(19) United States
(12) Patent Application Publication
(10) Pub. No.: US 2015/0107432 A1
(43) Pub. Date: Apr. 23, 2015

(54) DEVICE FOR OBTAINING ONE OR MORE ENGRAVING LINES FOR FOLDING AND FORMING A BOX WITH A CARDBOARD SHEET

(71) Applicant: Valiani, S.R.I., Certaldo (IT)

(72) Inventor: Franco Valiani, Certaldo (IT)

(73) Assignee: VALIANI, S.R.I., Certaldo (IT)

(21) Appl. No.: 14/403,551

(22) PCT Filed: Jun. 10, 2013
(86) PCT No.: PCT/IB2013/054749

§ 371 Date: Nov. 24, 2014

(30) Foreign Application Priority Data
Jun. 18, 2012 (IT) FI2012A000123

(51) Int. Cl. B26D 3/06; B31B 1/25

(52) U.S. Cl. CPC B26D 3/065; B31B 1/25
USPC 83/875

(57) ABSTRACT

The present invention refers to a grooving device comprising grooving means for realizing a grooving line on a sheet, said grooving means comprising: —A first and a second blade-holder support arranged one opposite the other in such a way as to allow the application of a first and of a second blade, one facing the other according to a pre-determined penetration angle (tt) in the sheet, said first and said second blade-holder support being eliding in such a way as to allow a lowering/lifting of the blades that can be applied on them; —An operating device for controlling the sliding of said first and second blade-holder support, said operating device comprising a piston that alides in the grooving device and a pair of fixing pins, each one fixed on one part to a respective blade-holder support. In accordance with the invention, on the opposite part, said pins are maintained in contact in a sliding manner along a surface of the piston.

### TECHNICAL FIELD

The present invention refers to the technical field relative to the working of cardboard in general, for the construction of boxes.

In particular, the invention refers to an innovative interchangeable cutting head which allows to create easily a grooving in the sheet in such a way as to realize a folding line.

### BACKGROUND ART

As it is well known in the state of the art, there exist from some time specific machineries for grooving sheets of cardboard, corrugated fiberboard or paperboard of different thicknesses, for example to create folding lines for the construction of a box.

The folding line is generally a V-shaped groove. It has also surprisingly been found that a type of groove that is particularly functional, in order to allow to fold the sheet, is that of trapezoidal shape and is the object of a preceding International patent application (PCT). This grooving shape has the advantage of allowing the folding of cardboard of a thickness superior also to the millimeter without incurring breakages or tears. Cardboard of the “pass par tout” type can therefore be worked for frames, “stretched”, corrugated, micro wave or laminil/foamboard cardboard sheets. This is because the groove terminates in a rectilinear strip and not in a cusp, which is a stress concentration point.

In the current state of the art, there are some machineries that are suitable for operating in an easy and quick manner a groove in the sheet, either V-shaped, trapezoidal or of another shape.

A machine 100 for grooving the cardboard sheet (and eventual custom-cutting of the same) is schematized for example in FIG. 1A of the prior art. The machine 100 foresees a worktop and a rotatable spindle to which, in an interchangeable manner, is connected a blade-holder head for the grooving. FIG. 1A shows the spindle and the blade-holder head assembled and closed by a protective carter. The protective carter, that is the spindle, is mounted slidingly on a binary 150 in the direction Y. The binary is in its turn translatable in a main direction (X), orthogonal to the direction (Y), through binaries that delimit the worktop. The system is therefore similar to a drafting table.

The head, not highlighted in FIG. 1A for simplicity purposes, has a substantially cylindrical shape and on the face opposite to that of the connection to the spindle mounts an inclined blade exactly as the blade of a cutter. The blade is interchangeable as well and can be removed when worn. The same is fixed to the blade-holder of the head by means of ordinary connection means such as a screw or a catch plate.

In order to obtain a groove, therefore, it is necessary to operate in a rather complex manner.

It is in fact necessary to create a first grooving line with the blade arranged in an inclined manner with respect to the head and that penetrates in an inclined manner for a certain depth in the cardboard. The spindle therefore presses on a mechanism that causes the sinking of the blade and, subsequently, the binary translates, realizing the first grooving line. Subsequently, it is necessary to extract the blade and rotate the head of 180° in such a way as to groove with a second line that runs parallel to the preceding one and that also penetrates transversally in the thickness of the cardboard at the same depth of the preceding one. The two grooves, on the basis of the depth of penetration set, intercept one another in a point, thus realizing a V-shaped groove.

In the case of trapezoidal groove, on the other hand, the realization is even more complex since, apart from the realization of two parallel lines, it is necessary to space said two lines between them in such a way as to create a grooving that does not terminate in a common point but rather leaves an interposed rectilinear edge. The tear of the strip thus delimited has to be operated then, which, once removed, leaves a groove of trapezoidal section in the cardboard.

It is therefore clear that these operations render the cutting of the strip particularly complex. In fact, not only does the cutting operation require more time but also, and above all, a software for controlling the movement, which is inevitably more complex, is necessary. It is in fact necessary to program the machine in such a way as to foresee the realization of two parallel lines for each groove.

Some cutting heads, proposed in other publications, render in part simpler the working of a V-shaped groove.

For example, in U.S. Pat. No. 5,033,346 a machine particularly suitable for realizing oval-shaped carvings with a V-shaped groove is described, particularly oval and round decorations on passepartout for picture frames. To that purpose, a blade-holder head is foreseen, which mounts two blades that are opposed and inclined in such a way as to converge in a point in common like a V. The blades are applied each one in a fixing channel and are fixed in position through a blocking pin integral to a manually-rotatable control knob. The control knob has a graduated scale, therefore by rotating it appropriately the extraction of the blade is controlled. Obviously, this solution, even if it allows in a single passing to realize a V-shaped carving, has the disadvantage of foreseeing a fixing and, above all, a totally manual adjustment of the blade. Obviously, this solution is not applicable for big-scale automatized production.

In EP 0985500 it is described a more modern machinery for realizing grooves and that foresees a rotatable cutting head with a single blade. Nevertheless, in this case, the single blade is mounted on a support assembly for the translatable blade. In particular, a fixed pivot is foreseen that is inserted in a receiving eyelet integral to a translatable piston downwards. In this manner, when the piston translates downwards, the support assembly for the blade translates integrally downwards, dragged through the pivot and the eyelet integral to the piston. In particular, when the grooving head touches the sheet, the piston starts to translate, therefore dragging the blade-holder assembly and causing the exit of the blade.

This solution, however, has different technical inconveniences.

In particular, the rotatable connection through the pivot that is inserted in the eyelet integral to the piston is scarcely resistant. The pivot, which rotates in its eyelet during the translation of the piston, wears easily and has to support a load that can cause its breakage easily.

Besides, a thus made arrangement is not at all simple since it requires that the whole assembly that mounts the blade connects to the piston through the precise insertion of the pivot.

It is also noted that the solution proposed in said patent application not only describes a single blade but, above all, such a solution does not lend itself well to the mounting of two opposed blades because of the significant encumbrance, in this case due to a mounting of the blade-holder assembly internally to the cutting head to which it is added the presence of the end screw that serves to fix the blade in the extracted position selected.

### DISCLOSURE OF INVENTION

It is therefore the aim of the present invention to provide a new type of cutting head for a cardboard sheet that solves at least in part said technical inconveniences.

In particular, it is the aim of the present invention to provide a cutting head for a sheet of cardboard, corrugated fiberboard and the like, which allows to realize a groove of any section, for example V-shaped or trapezoidal, in a precise and quick manner and with a sliding and extraction system of the blade that is long-lasting and of simple mounting.

These and other aims are therefore obtained with the present head or grooving device in accordance with claim 1.

Such a grooving device (1) comprising grooving means (7, 8, 10, 11) for realizing a grooving line on a sheet, said grooving means (7, 8, 10, 11) comprising:

A first (7) and a second (8) blade-holder support arranged one opposite the other and configured in such a way as to allow the application of a first (10) and of a second blade (11), one facing the other according to a pre-determined penetration angle (α) in the sheet, said first (7) and second blade-holder support (8) being sliding in such a way as to allow a lowering/lifting of the blades that can be applied on them;

An operating device (4, 5, 6) for controlling the sliding of said first and second blade-holder support, said operating device comprising a piston (4) that slidable arranged into the grooving device (1) and a pair of fixing pins (5, 6), each one fixed on one part to a respective blade-holder support.

In accordance with the invention, on the opposite part to that of connection with the blade-holder supports, said pins (5, 6) are maintained in sliding contact along a surface of the piston (4).

In this way, all the technical inconveniences mentioned are easily solved.

In particular, there does not exist anymore a fixed connection constraint between the pivot, connected to the blade-holder support, and the piston, but the pivot is now in brushing contact with a surface of the piston. When the piston moves downwards it transmits the force to the pivot which, during the lowering movement of the relative blade-holder support to which it results connected, brushes on the contact surface with the piston. This solution significantly reduces the wear and the stresses that act on the pivot itself, thus rendering this solution much more long-lasting in time.

Moreover, the mounting is extremely more simplified since it is not necessary anymore to insert a pivot in its own eyelet but it is enough to put it in the position of contact with the piston.

Advantageously, the base of the piston is worked in such a way as to present two inclined faces in contact with said fixing pins (5, 6).

On the basis of the inclination with which the piston has been worked, it is possible to transmit and therefore adjust much better the translation force desired.

Advantageously, said fixing pins are arranged according to a pre-determined inclination angle.

In particular, in the case of inclined surface of the piston, the pins are entirely reclined on the inclined surface of the piston for a better contact.

Advantageously, elastic means (50) are foreseen for returning said blade-holder supports in lifted position and maintain the pins in contact with the piston.

Advantageously, the first and the second blade-holder support are mounted slidingly, each one along a sliding seat (40) obtained in the external perimeter of the body of the device.

This solution, with respect for example to the state of the art of EP0985500, has the advantage of an easy mounting of the blade-holder support and greater possibility of sliding. In EP0985500 the blade-holder supports are internal to the device and this complicates significantly the mounting thereof and creates encumbrance problems.

Advantageously, the first and the second blade-holder support comprise respectively a pivot (12, 13) mounted rotatable around an orthogonal axis to the surface of the blade-holder support to which it results applied in such a way that its rotation allows to bring one of its ends in a position destined to the positioning of the blade on the blade-holder support, so as to block it.

This solution has the further advantage that the blocking system of the blade, unlike the screw described in EP0985500, does not interfere with the sliding of the blade-holder support and is, above all, simpler from the constructive point of view. The blocking pivot is in fact external to the blade-holder supports and does not interfere with the sliding thereof.

In the case of EP 0985500 the blade-holder support is in fact internal to the device and there is a transversal screw that blocks the end of the blade but, in that position, interferes with the sliding stroke for the support itself, which is impeded from sliding beyond certain lengths and, above all, renders the mounting of two opposed blades difficult.

Advantageously, said first (7) and second blade-holder supports (8) are arranged symmetrically with respect to the vertical surface (β) passing through the longitudinal axis (100).

Advantageously, two spacers (15) are foreseen, fixed to the apex of the grooving device.

Advantageously, such spacers are interchangeable.

Advantageously, such spacers can be, for example, connected magnetically.

Last, it is here described a machinery (100) for grooving cardboard comprising a grooving device (1) as previously described.

### BRIEF DESCRIPTION OF DRAWINGS

Further features and advantages of the present grooving device 1, according to the invention, will result clearer with the description that follows of some embodiments, made to illustrate but not to limit, with reference to the annexed drawings, wherein:

FIG. 1A shows a grooving machinery in accordance with the state of the art;

FIG. 1 and FIG. 2 show two axonometric views of the present device;

FIG. 3 shows a use phase in which a right-angle grooving line is realized;

FIGS. 4A and 4B show in section the mechanism that controls the lowering and the lifting of the blade-holder supports;

FIG. 5 shows, in an axonometric view, the direction of the force F′ applied by the spindle on the piston for causing the lowering of the piston 4 and therefore the sliding downwards of the blade-holder supports;

FIG. 6 shows in a further axonometric view the seats where the blade-holder supports are arranged slidingly;

FIG. 7 shows a detail of the plate 16 used for realizing the sliding guide of the blade-holder support;

FIG. 8, always in an axonometric view, describes the two opposed blade-holder supports, and highlights also the blocking system of the blade on the blade-holder support;

Figures from 9 to 11 show further axonometric views for highlighting the spacers 15 or front foot.

FIG. 12 shows, always in an axonometric view, the grooving head, highlighting well the piston that is connected to two blade supports through the pivots and, further, the spacers and the superior part where the connection to the spindle takes place;

FIG. 13 shows a variant that allows an adjustable sinking of the spindle 4A in such a way as to vary and be able to adjust every time the stroke of the piston 4 and therefore the level of lowering of the blade-holder supports (7, 8).

### DESCRIPTION OF SOME PREFERRED EMBODIMENTS

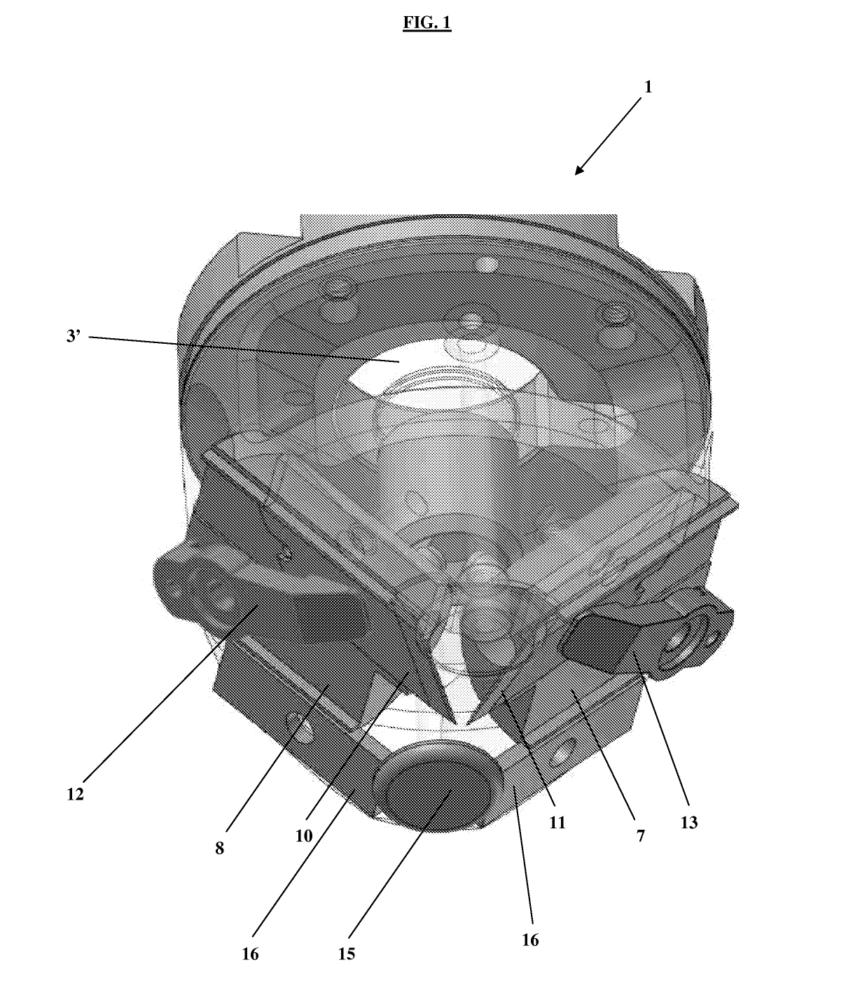

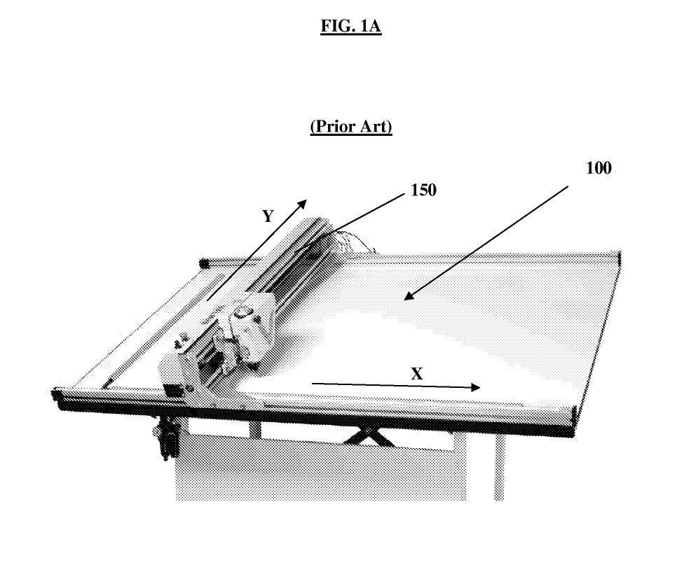

FIG. 1 represents a grooving device 1 (also called grooving head 1) in accordance with the invention.

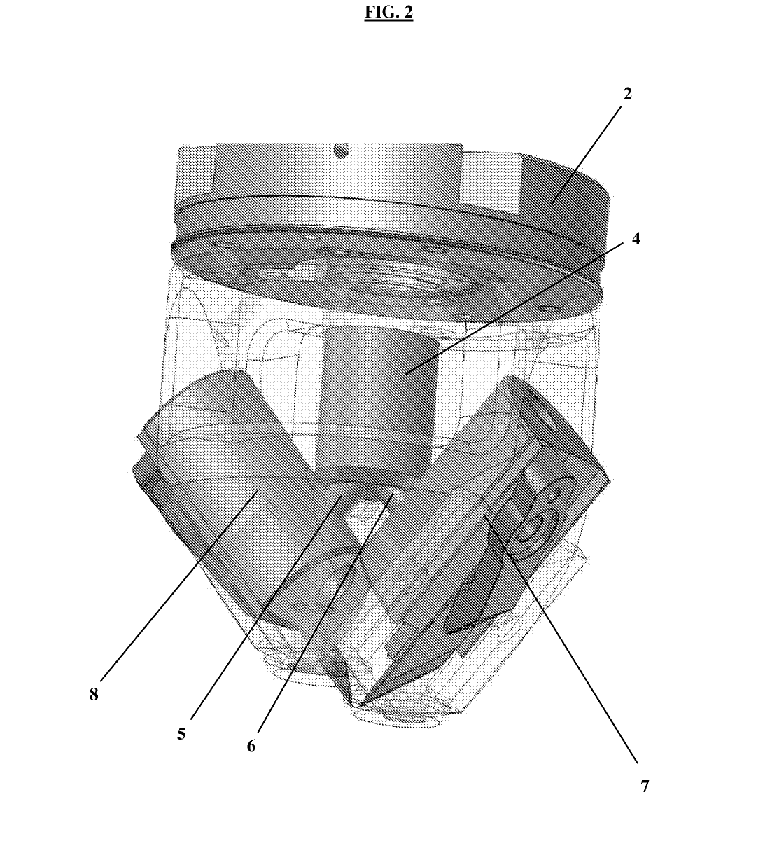

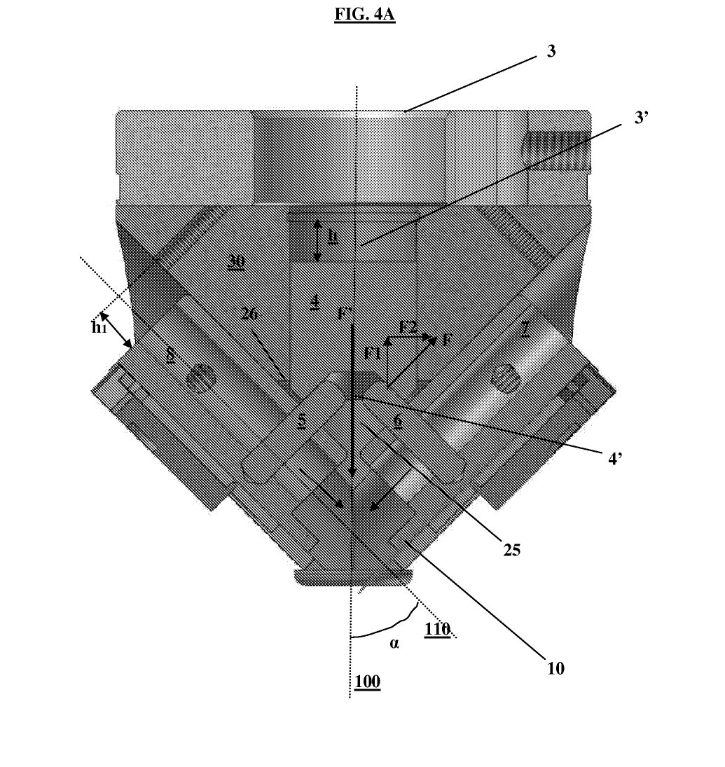

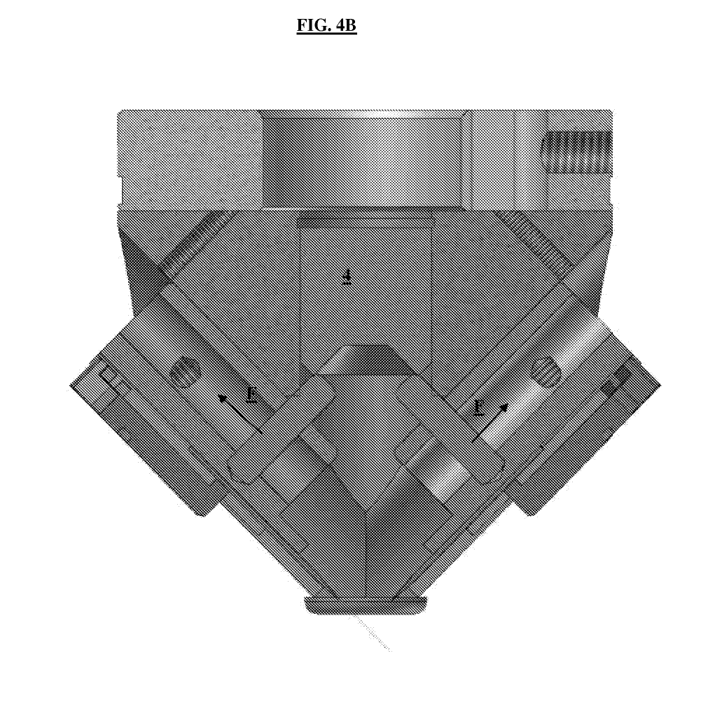

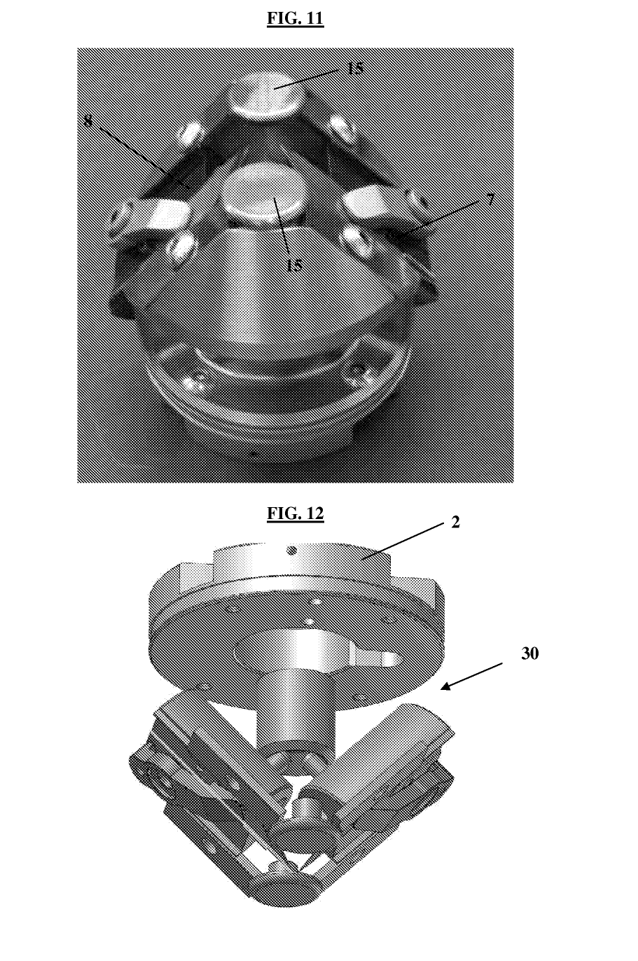

The device 1 foresees a superior part 2, well highlighted for example in FIG. 2 and in FIG. 10, of a substantially cylindrical shape, and an inferior part 30 (evident as well in FIG. 10 or in FIG. 6). FIG. 12, as well, highlights well the superior and inferior part. The superior part 2 is axially holed through a central opening 3 that gives access to a channel 3′ (see also FIG. 4A), in such a way as to allow the passage and the fixing, in said channel, of a spindle that is not represented in the figure for simplicity purposes.

FIG. 12 shows, in correspondence of the opening 3, a loop that serves to block rotationally the spindle with respect to the device 1, for example through a key. In this manner, when the spindle rotates, the device 1 is dragged integrally in rotation.

The spindle is part of the grooving machine described in the background art and is not the object of the present description.

The present grooving head 1 is therefore applicable, preferably interchangeably, to a spindle of a grooving machine, for example as the one described in the background art.

As per the background art, the spindle is generally of the rotatory type in such a way that any grooving lines can be realized, and not necessarily a single rectilinear section.

As it is well highlighted in the section of FIG. 4A, the opening 3 forms the access to the channel 3′ in which a piston 4 is slidingly placed. The piston 4 is sliding in the channel 3′ for a certain quantity (h). On the opposite part, the channel 3′ is interrupted by a stop 25.

In the preferred embodiment of the invention, in an absolutely non-limiting manner, the piston 4 can have an overall height in the order of about 17 mm, while the overall length of the channel 3′ can be in the order of about 25 mm. In this manner, there is a stroke h of about 8 mm.

Naturally, any size can be realized without for this moving apart from the present inventive concept.

As it is better described in detail below, the piston 4 is controlled in translation in the channel 3′ through the spindle (not represented in figure) which, apart from conducting in rotation the entire device 1, presses on the piston 4 itself, obliging it to slide for a certain quantity towards the stop 25.

As always shown in the section of FIG. 4A, two blade-holder supports (7, 8) are foreseen, opposed one to the other and connected to the body of the device 1 according to an inclined direction.

Such two blade-holder supports (7, 8) are well visible also in FIG. 1, FIG. 2 or, for example, FIG. 11.

The device, in its entirety, is therefore symmetrical with respect to the longitudinal axis 100 (also rotation axis).

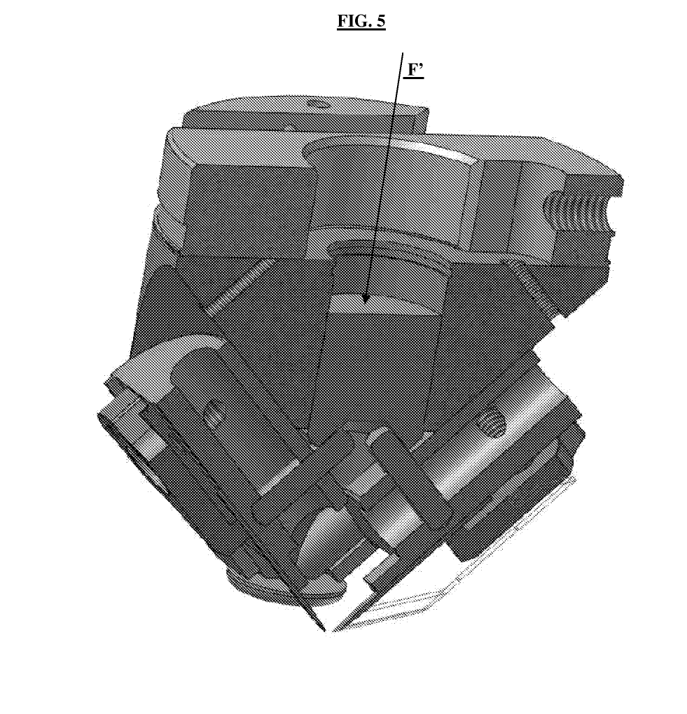

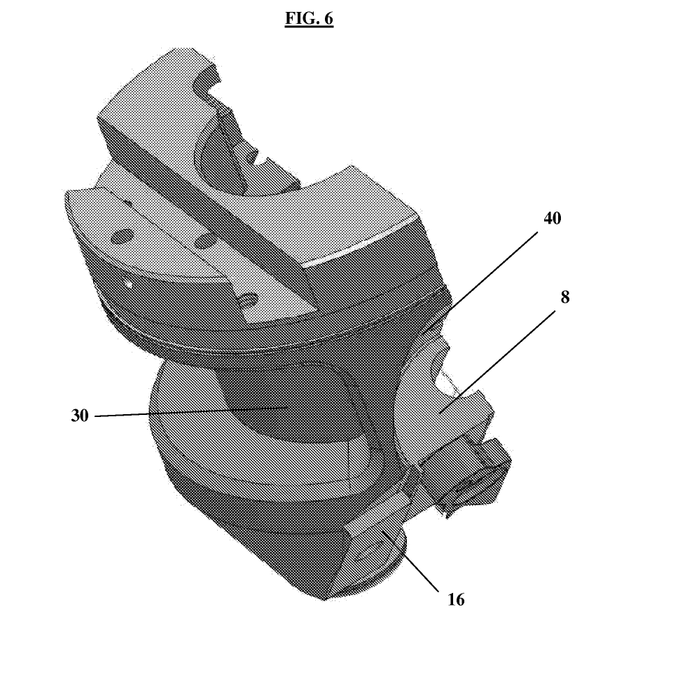

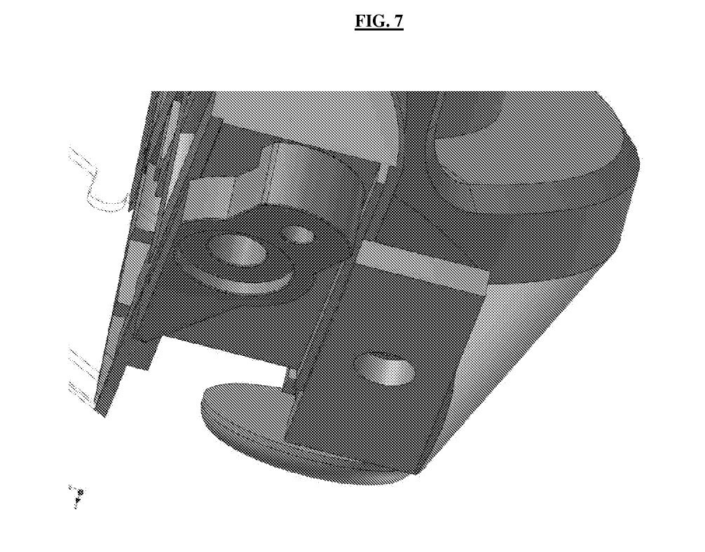

The two blade-holder supports (7, 8) are therefore inclined with respect to the longitudinal axis 100 of a pre-determined angle (α) in such a way as to converge towards a common apex. FIG. 4A describes with (α) the angle comprised between the longitudinal axis 100 and the axis 110 of a blade-holder support. Said two axes (100, 110) belong to a common surface (β), that is the cutting surface of FIG. 5 or FIG. 6, which is a symmetry surface.

It is highlighted how the present grooving device presents, above all, central symmetry with respect to the axis 100.

As always shown in the section of FIG. 4A, two fixing pins (5, 6) are then foreseen, which block each one respectively, through appropriate insertion seats, in the two blade-holder supports (7, 8).

The two blade-holder supports (7, 8) are mounted slidingly on the inferior part 30 of the device through appropriate sliding seats 40.

In particular, as shown well in the axonometric view of FIG. 6, the two blade-holder supports (7, 8) are mounted slidingly through the seats 40 obtained in the body of the device, in particular in the inferior part 30 and on the external perimeter of the device itself.

In this manner, the mounting is significantly simplified.

In order to enhance the sliding of each blade-holder support, two plates 16 are therefore fixed at both parts of each blade-holder support in such a way as to define for each blade-holder support a sliding binary (see for example FIG. 9 or FIG. 10).

Going back to FIG. 4A, the limits of the stroke of the blade-holder support are defined by the inferior stop 25 and by a superior stop 26 obtained in the body of the inferior part 30e with which the fixing pins interfere.

Simple return springs, not represented in FIG. 4A for simplicity purposes, allow to return in lifted position, in contrast against the stop 26, the pins connected to the two blade-holder supports (7, 8). In this manner, the two blade-holder supports always tend to be returned in lifted position and remain in contact with the piston (as better described in detail below).

FIG. 10, for example, shows the end of a spring 50 fixed in a fixed point of the body 30 (a fixed pin set in the body 30) on one part and inserted in a channel obtained in the body of the blade-holder support. The spring, by its opposed end, is then fixed to a fixed point of the blade-holder support itself in the channel obtained in it (not visible in the figure). In this manner, the spring, appropriately regulated, exerts a constant return force F (see FIG. 4B) which tends to push the blade-holder support constantly upwards.

FIG. 4A highlights the stroke section (h1) of the two blade-holder supports along the sliding seats 40.

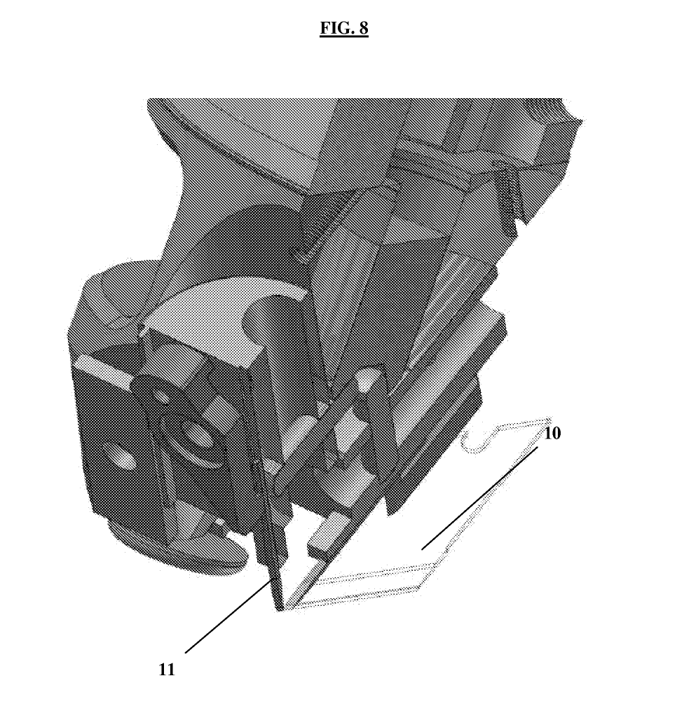

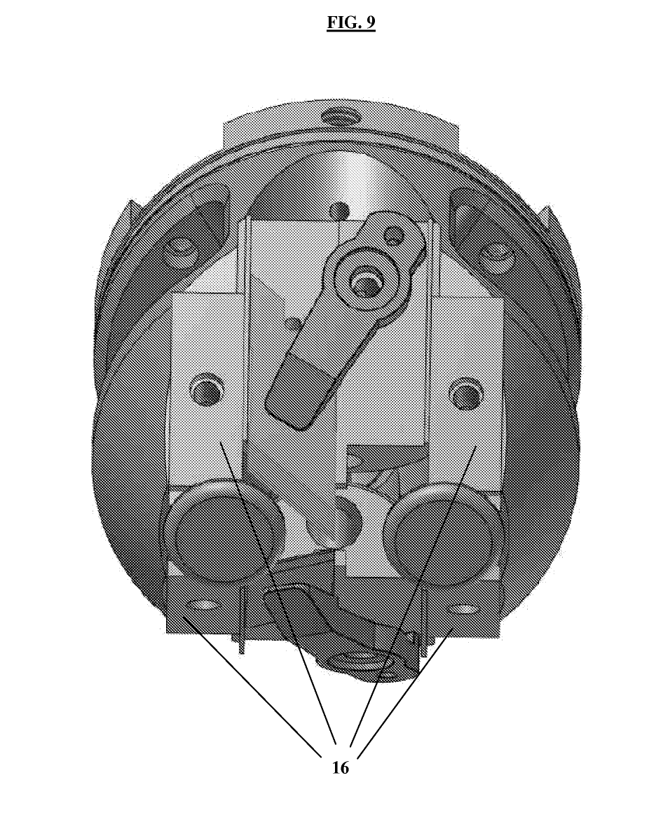

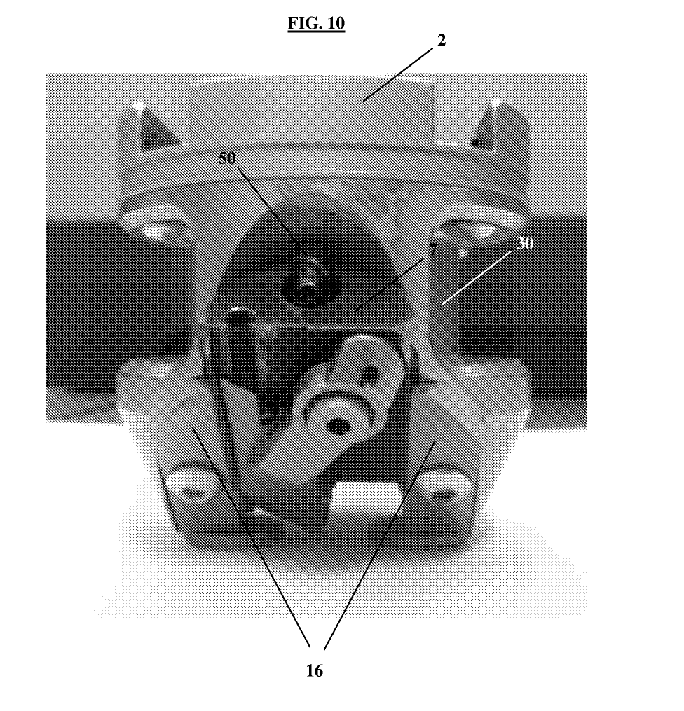

The kinematism described allows to move apart/move closer between them the apexes of the two blades (10, 21) from/towards a common apex point (see for example FIG. 8). In particular, this kinematism allows to make the blades exit through the sliding of the blade-holder supports, when the spindle presses on the piston 4. The pressure force F′ on the piston beats the return force of the springs F, causing the sliding of the blade-holder supports along their guides 40. The sliding of the blade-holder supports reciprocally makes the two blades fixed on the supports come closer towards a common apex. When the spindle releases the piston, then the springs 50 return in lifted position the blade-holder supports, thus bringing the blades back in retracted position.

As shown in FIG. 4B, when the spindle that presses on the piston 4 does not act, also the piston is lifted. The lifting of the piston is obtained thanks to the continuous contact of the pins (5, 6) with the piston itself, the pins transmitting the return force of the spring to the piston. When the pins (5, 6) reach the mechanic stop against the stop stroke 26 (see position in FIG. 4B) the action of sliding of the blade-holder supports and of the piston is stopped. The pins (5, 6) are of such a length as to maintain a contact of continuous brushing with the base of the piston 4 during its vertical stroke (h) from the lowered position to the lifted position and vice-versa. This is easily obtained by having two inclined faces (for example by digging a cone) in correspondence of the inferior base of the piston itself with the pins that in inclined position are reclined on said faces of the piston. The component of the return force F of the spring, along the axis 110 of the blade-holder support, is transmitted via the pivots 5 and 6 also to the piston 4 and, thanks to the inclined faces of contact, is decomposed according to two components (F1, F2) and of which one (the F1 in the case of FIG. 4A) facing upwards. In the same manner, but with exactly opposed directions, the thrust action of the spindle on the piston downwards (see direction of the arrow F′ applied to the piston 4 always in FIG. 4A) is transmitted to the blade-holder supports through the pivots. The force F′ beats the action of return force F of the springs 50 and causes the translation of the two blade-holder supports up to reaching the stop stroke 25 through a brushing of the pivots along the inclined faces of the piston. When the force is released an inverse return motion takes place, and always with the pivots that brush along the inclined surface of the piston with which they result in contact.

FIG. 5 shows in an axonometric view the position in which, thanks to the action of thrust F′ of the spindle not represented in figure, the piston 4 translates up to the stop stroke, dragging behind, through the pivots (5, 6), the two blade-holder supports (7, 8).

FIG. 1 shows clearly, with the axonometric view from the bottom, the two blade-holder supports (7, 8) on which the blades 10 and 11 are respectively arranged.

The blade-holder supports form, each one, a flat surface which thus creates an inclined support surface on which the blades (or the cutters) rest.

The blades are fixed to said inclined surfaces in a removable manner and this is obtained easily through the appropriate application to each inclined surface of a rotatable pivot. The pivot (12, 13) is therefore hinged in a point and can be rotated in such a way as to be arranged with one of its ends above the blade and therefore keeping it still in position. The pivot (12, 13) is hinged thanks to a screw that presents an hexagonal countersink in the head and which allows to saw the pivot itself against the surface of the blade, fixing it solidly.

The flat surface terminates with a perpendicular pivot that is visible in FIG. 10 and that exits from the support itself. The pivot serves as mechanic stop against which the interchangeable blade goes in the mounting phase, in such a way as to act as a reference for the application of the blade itself. On the basis of the groove to be realized, for example a V-shaped groove, it is important that the two blades are specular between them.

It is then possible, in a variant, to foresee that the surface of the blade-holder supports, destined to support the blade, both present a seat in which a complementary blade-holder pocket can be applied, which block the support, always through the pivot (12, 13) as described. The pocket, of metal, contains the blade in an interchangeable manner and makes that there is direct contact between blade and pivot.

It is clear that other equivalent fixing modes could be foreseen, for example also foreseeing blades with a hole and an inclined surface provided with a threaded receiving hole in such a way that the blade can be screwed in position directly or through a blade-holder pocket.

Going on with the structural description of the invention, always FIG. 1 show two spacers 15, also called front feet 15.

The two spacers are well highlighted also in FIG. 9, FIG. 10 and FIG. 11.

The two spacers are therefore fixed to the apex of the inferior portion 30 and can be fixed in different manners.

They can, for example, be fixed permanently through gluing systems or rivets, or they can be interchangeable, for example through the use of magnets or screws.

As shown in FIG. 10, the function of the spacer 15 is important because it lifts of a pre-determined level the entire device 1 when this rests on the sheet to groove. This makes that the blades are found initially in a lifted position with respect to the underlying sheet to groove. The level of lifting depends on the thickness of the spacer selected. When the spindle acts on the piston 4, the blade-holder supports translate, dragging the blades that penetrate for a certain depth in the underlying sheet. The depth of penetration is for example the one defined by the stroke h′ of the two blade-holder supports until the pins arrive to the stop strokes 25 thereof.

By varying the thickness of the spacers 15 applied it is controlled (increases or decreases) the level of lifting and lowering of the blades with respect to the underlying surface (sheet). This allows to control easily the depth of penetration of the blades which, at equal stroke h1, penetrate more or less in the underlying sheet depending on if they are more or less lifted from the sheet itself in the initial position, with the blade-holder supports all lifted and therefore with the spindle that does not thrust on the piston 4. In this manner, in an easy way, the shape of the carving is controlled. According to the spacer 15 selected, the stroke h′ can be such so that the blades penetrate up to converging in a common point for realizing a V-shaped carving or they can remain more or less lifted (that is they do not intercept), thus creating a longer or narrower trapezoidal groove.

Moreover, the use of two opposed spacers 15 confers a good stability to the device itself, also when it operates in proximity of the edge of the sheet with just one of the two spacers in contact on the sheet.

It is clear that, even if there are two stop strokes 25 and 26, the spindle could be controlled in such a way as to cause a lowering of the piston 4 not necessarily up to the stop stroke.

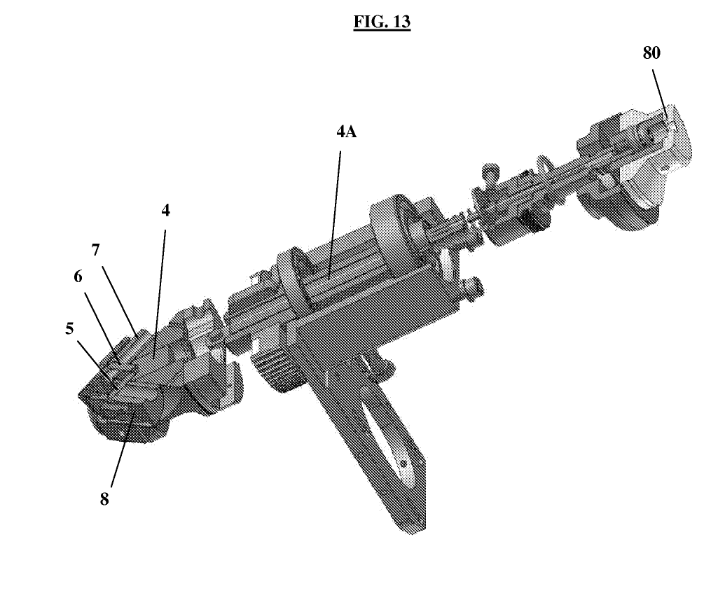

To that aim, for example, FIG. 13 shows a variant that is particularly advantageous. It shows a micrometric adjustment system of manual blades. In particular, it is possible to foresee a knob 80 at an end of the spindle 4A and whose rotation controls a manual lowering/lifting of the opposed end that goes in contact against the underlying piston 4. In this sense, it is not necessary that the piston is made to slide by force up to its stop stroke but, advantageously, it is possible a priori to control the movement of the piston, whose stroke can therefore be inferior to its maximum stroke (h), and adjusted with precision.

The return force of the springs 50 assures a stable contact and a stable position of the piston 4.

In this manner, through the combination with various sets of spacers of different thickness, it is possible to obtain different grooving shapes, widths and depths.

In a further variant of the invention, the two blade-holder supports (7, 8) could also be realized not as two separate components but as a single piece appropriately shaped so that two opposed and specular blades can be applied to it.

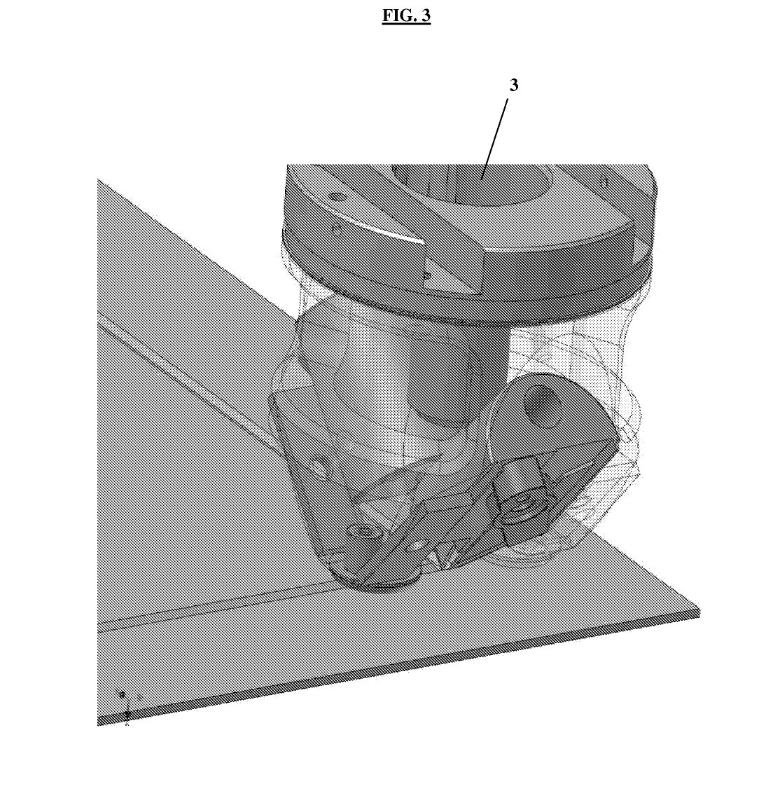

An example of use is represented in FIG. 3.

The carving of FIG. 3 is v-shaped but, as said, cuts of any shape, among which the trapezoidal shape, can easily be obtained.

The head rests on the underlying sheet as per FIG. 10 and connected to the spindle. The spindle acts by pressing on the piston 4 and causing the penetration of the blades in the sheet. The level of penetration depends on the spacer 15 selected. At this point the spindle is translated along a pre-defined path in such a way as to obtain a carving line. FIG. 3 shows two V-shaped cutting sections placed at a right angle.

It is clear that in accordance with the invention, thanks to the use of two opposed blades, it is now possible to realize the groove in a single passing, without the need to rotate the head and make a passing parallel to the preceding one.

1. A grooving device (1) comprising grooving means (7, 8, 10, 11) for realizing a grooving line on a sheet, said grooving means (7, 8, 10, 11) comprising:
A first (7) and a second (8) blade-holder support arranged one opposite the other in such a way as to allow the application of a first (10) and of a second blade (11), one facing the other according to a pre-determined penetration angle (α) in the sheet, said first (7) and said second blade-holder support (8) being sliding in such a way as to allow a lowering/lifting of the blades that can be applied on them;
An operating device (4, 5, 6) for controlling the sliding of said first and second blade-holder support, said operating device comprising a piston (4) that slides in the grooving device (1) and a pair of fixing pins (5, 6), each one fixed on one part to a respective blade-holder support;
characterized in that, on the opposite part, said pins (5, 6) are maintained in contact in a sliding manner along a surface of the piston (4).

2. A grooving device (1), as per claim 1, wherein the base of the piston is worked in such a way as to present two inclined faces in contact with said fixing pins (5, 6).

3. A grooving device (1), as per claim 1 or 2, wherein said fixing pins are arranged according to a pre-determined inclination angle.

4. A grooving device (1), as per one or more of the preceding claims, wherein elastic means (50) are foreseen for returning said blade-holder supports in lifted position and maintain the pins in contact with the piston.

5. A grooving device (1), as per one or more of the preceding claims, wherein the first and the second blade-holder support are mounted slidingly each one along a sliding seat (40) obtained in the external perimeter of the body of the grooving device (1).

6. A grooving device (1), as per one or more of the preceding claims, where the first and the second blade-holder support comprise respectively a pivot (12, 13) mounted rotatable around an orthogonal axis to the blade-holder support surface to which it results applied in such a way that one of its ends can rotate, arriving to a position in which it blocks the blade.

7. A grooving device (1), as per one or more of the preceding claims, wherein said first (7) and second blade-holder support (8) are arranged symmetrically with respect to the vertical surface (β) passing through the longitudinal axis (100).

8. A grooving device (1), as per one or more of the preceding claims, wherein two spacers (15) are foreseen, fixed to the apex of the grooving device.

9. A grooving device (1), as per claim 8, wherein said spacers are interchangeable.

10. A grooving device (1), as per claim 8, wherein said spacers are connected magnetically.

11. A machinery (100) for grooving cardboard comprising a grooving device (1) as per one or more of the preceding claims.
